(19) United States
(12) Patent Application Publication
(10) Pub. No.: US 2023/0091681 A1
(43) Pub. Date: Mar. 23, 2023

(54) METHOD FOR DETERMINING THE GEOMETRY OF A DEFECT BASED ON NON-DESTRUCTIVE MEASUREMENT METHODS USING DIRECT INVERSION

(71) Applicant: ROSEN SWISS AG, Stans (CH)

(72) Inventors: Andrey Danilov, Stans (CH); Matthias Peussner, Westerkappeln (DE)

(21) Appl. No.: 17/602,957

(22) PCT Filed: Apr. 9, 2020
(86) PCT No.: PCT/EP2020/060189

§ 371 Date: Oct. 28, 2022

(30) Foreign Application Priority Data
Apr. 9, 2019 (EP) 19168280.6
Apr. 10, 2019 (EP) 19168531.2

(51) Int. Cl. G01N 29/44; G01N 29/24; G01N 27/82

(52) U.S. Cl. CPC G01N 29/4481; G01N 29/4427; G01N 29/4436; G01N 29/2412; G01N 27/82

(57) ABSTRACT

Method for determining the geometry of one or more real, examined defects of a metallic, in particular magnetizable object, in particular a pipe or a tank, by means of at least two reference data sets of the object generated on the basis of different, non-destructive measurement methods,

wherein the object is at least partially represented on or by an at least two-dimensional, preferably three-dimensional, object grid, in an EDP unit,
wherein an output defect geometry, in particular on the object grid or an at least two-dimensional defect grid, is generated by inversion of at least parts of the reference data sets, in particular by at least one neural network (NN) trained for this object, a respective prediction data set for the non-destructive measurement methods used in the generation of the reference data sets is calculated on the basis of the output defect geometry by a simulation routine, a comparison of at least parts of the prediction data sets with at least parts of the reference data sets is carried out and, depending on at least one accuracy measure, the method for determining the geometry of the defect is terminated or an iterative adjustment of the output defect geometry to the geometry of the real defect(s) is carried out, as well as methods for determining a load limit (FIG. 1).

The present invention relates to a method for determining the geometry of a defect and to a method for determining a load limit of an object subjected to pressure, at least during operation.

Such objects are inspected for defects using non-destructive measurement methods. The results of the measurement methods are evaluated to infer the type and/or size of defects. Based on this, it can then be determined how heavily the object can be loaded, for example, or whether and to what extent repair measurements or replacement of the object are necessary. To prevent unnecessary measurements, it is important to be able to describe the defects and their geometry as precisely as possible.

An example of such an object to be examined is a pipeline. One of the essential objects of pipeline inspections, especially with so-called intelligent pigs, is the prediction of safe operating conditions resulting from the pipeline condition. In particular, pipeline operators are interested in the condition of any welds and the number and size of defects. Defects are, for example, areas of metal losses due to corrosion, cracks or other weakening of a wall of an object intended in particular for the storage or transport of liquid or gaseous media. These include, for example, pipes, pipelines or tanks.

Knowledge of the maximum pressure applicable to a pipeline (“burst pressure”), above which the pipeline is destroyed, is relevant to the operating pressures that can be set in the pipeline. The burst pressure is used to quantitatively determine the load limit.

Accordingly, the accurate prediction of this pressure is important. Currently, for the calculation of this limit, a defect is only approximated in terms of its length, width and depth and is therefore considered as a box. Especially for metal losses due to corrosion on the outside or inside of a pipeline, however, this required conservative approach is disadvantageous, since the simplified geometric figures necessarily overestimate the actual structure of the defect. This leads to the underestimation of the burst pressures of the object and consequently to the underestimation of the allowed operating pressures. However, an object that can be operated at a higher pressure, such as a pipeline or a gas tank, can be operated much more economically.

While MFL examinations are preferably used for detecting defects due to corrosion, other methods, in particular those utilizing ultrasound, are used for detecting cracks on the inside or outside of an object. These non-destructive measurement methods include electromagnetic-acoustic methods (EMAT methods), in which sound waves, especially in the form of guided waves, are generated in the pipe wall of the object to be examined due to eddy current-induced magnetic fields, as well as methods directly introducing ultrasound into the object wall, hereinafter referred to as ultrasonic methods. In the state of the art, cracks close to the surface, in particular smaller cracks, are also searched for using eddy current measurement methods, hereinafter referred to as EC measurement methods.

The state of the art for measuring the corrosion of an object is to have scans of magnetic flux leakage data (MFL data) based on magnetic flux leakage measurements (MFL measurements) to determine the size of the (corrosion) defects evaluated by specially trained individuals. The same applies to the evaluation of measurement data obtained on the basis of EMAT, UT and EC measurement methods. The signals displayed in the scans are parameterized and evaluated in boxes. On the one hand, the assumptions necessary for this evaluation of the measurement results, also called sizing, are proprietary. On the other hand, the interpretation of the measurement results is strongly influenced by the empirical values of the evaluating persons. Ultimately, the only way to ensure the quality of the predictions is to examine the pipeline on site. This in turn is accompanied by high costs for the operators. The most widely used industry standard, API 1163, describes the adverse effects of this simplified approach. It is well documented that the quality of this approach is highly dependent on the knowledge of the persons looking at it. The approaches carried out in practice are always an interpretation, influenced by subjective factors, of the data obtained by a measurement run with a respective non-destructive measurement method.

Finally, the joint occurrence of several types of defects or defects such as corrosion and cracks (crazing) is particularly problematic, especially in more complex geometries such as welds. Against the background of increasingly stringent safety requirements, e.g. for pipelines, high safety margins are applied for the combined occurrence of defects with regard to the burst pressure. In this case, a pipeline is usually operated well below the maximum permissible pressure.

In addition, approaches are known from scientific, i.e. theoretical, observation in which successive variation and iterative methods of an assumed defect geometry are used to achieve the most accurate possible simulation of the measured signals via forward models. For example, neural networks are used here. Theoretically, these approaches can yield solutions in terms of resulting defect geometry; however, these solutions are not necessarily realistic. This is especially true for complex data sets that lead to unexpected, exotic, and incorrect solutions under certain inverse problems. While in well-defined and delimited test scenarios such scientific models yield a solution to the described problem in the form of defect geometries, this has not yet been successful for real measurement data, which exhibit a variety of perturbations.

The object of the present invention is to provide a rapid way to reconstruct the geometry of a real defect and to perform as accurate a calculation as possible of the load limit of an object afflicted with one or more defects.

The object is solved by a method according to claim 1 and, with respect to the determination of a load limit, namely the burst pressures, by a method according to claim 16. Advantageous embodiments of the invention can be found in the dependent claims referring back to these claims and in the following description.

According to the invention, it is intended to carry out the determination of the geometry of one or more defects by means of at least two reference data sets of the object generated via different, non-destructive measurement methods. Such a method according to the invention for determining the geometry of one or more real, examined defects of a metallic and in particular magnetizable object, in particular a pipe or a tank, on the basis of at least two reference data sets of the object generated via different, non-destructive measurement methods, comprises an at least partial representation or mapping of the object on or by an at least two-dimensional, preferably three-dimensional object grid by means of an EDP unit. According to the invention, an output defect geometry is generated, in particular on the object grid or an at least two-dimensional defect grid, by inversion of at least parts of the reference data sets, in particular by at least one neural network trained for these objects. The output defect geometry can be mapped directly onto or represented by the object grid, but it can also be in a parameter representation, for example on an at least two-dimensional defect grid. Here, the determination of the output defect geometry is done by a direct inversion. Based on the result, the reference data sets determined by means of the respective different non-destructive measurement methods, which are based on the results of corresponding measurements, are inferred to the geometry, which results in the corresponding measurement results for the different nondestructive measurement methods used. For simple geometries, an analytically obtained inverse function can be used. However, for more complex object geometries or defect geometries, a neural network trained for this object preferably performs the inversion. To do this, the neural network can generate output that is assigned to an object grid representing the object. This assigns information about the presence of defects to elements of the object grid, cells or nodes. Information about the type of defect, such as cracks, corrosion defects, or lamination defects, can also be included in the output and assigned to the object grid.

Furthermore, according to the invention, a determination, in particular a generation, of respective prediction data sets, i.e. data sets suitable for the non-destructive measurement method, is carried out on the basis of the output defect geometry. This is done by simulation using a simulation routine or by assigning a measurement, which matches the respective reference data set. Furthermore, at least parts of the prediction data sets are compared with at least parts of the reference data sets. Depending on at least one accuracy measure, the method for determining the geometry of the defect is terminated or an additional iterative adjustment of the output defect geometry to the geometry of the real defect(s) is performed. Thus, the geometry of the defect or at least a first output defect geometry can be created for subsequent iterative adjustment and solution in a particularly simple and fast way.

The use of at least two reference data sets obtained by different non-destructive measurement methods in the inversion increases the reliability and accuracy of the method. The determination of an output defect geometry, based on which prediction data sets are computed for both or all reference data sets underlying the evaluation, which sufficiently match the reference data sets, cannot be obtained by an analytically obtained inverse function except for the simplest geometries. Preferably, therefore, at least one neural network trained for this object is used for the inversion.

Different non-destructive measurement methods are often defect-specific, so that the use of at least two reference data sets obtained by different, non-destructive measurement methods results in surprising synergy effects, especially when using neural networks. For example, while MFL measurement data often detects corrosion-specific defects and EMAT measurement methods are more commonly used for crack detection, it has been shown that by using corresponding reference data sets together, not only allows to describe and determine a greater complexity of any defects, but moreover, solutions with nonsensical geometries are surprisingly more often avoided from the theoretically available plurality of solutions. This is attributed to the synergistic effects resulting from the training of the neural network in particular by considering the same object and corresponding to the identical defect geometry.

Preferably, a training simulation routine generates training data by simulations based on different training geometries, with which a neural network is trained to invert the measurement data. The simulation routine can also be used as the training simulation routine. The training geometries each contain different types of defects, each with a different shape or dimension. In particular, this includes both cracks and corrosion defects. Furthermore, the training simulation routine can simulate training data for different operating conditions of the non-destructive measurement methods based on the training geometries. For example, different training data for different measurement runs of the nondestructive measurement method, for example with different distances of the sensor from the object, can be simulated for a training geometry. Training data can also be generated for defect shapes contained in different object geometries, for example for an arrangement in a weld. Training data are data pairs from the object geometries or the object grids representing the object geometries with and/or without defects and the reference data sets obtained on the basis of the respective geometries.

Preferably, the neural network is trained based on data from a database containing simulated measurements. By using already simulated measurements, the effort for training the neural network is reduced, since it then only involves the actual adjustment of the neural network and not also the additional simulation of training data. In addition, such a database may contain a variety of different training defect geometries, including, for example, those found in the forms of welds. Preferably, data on particularly frequently occurring geometries and/or types of defects are clustered in a corresponding database. By using data from such a database, the neural network is particularly well trained to recognize frequently occurring defect geometries. To further simplify the training of a neural network, an already previously trained neural network can be used as a starting point. A previously trained neural network can also be trained with database data, but the training is interrupted at an appropriate time. The properties of the previously trained neural network, such as the weights of the connections, are stored. Another later training of a previously trained neural network uses the stored properties of the network as a starting point.

Preferably, training data obtained from the simulation of different training geometries is entered into such a database. This reduces the computational effort, since simulations do not have to be performed multiple times.

Preferably, a feature extractor, which can also be designed as another neural network, extracts input data for the neural network from a reference data set. The step of extracting input data from a reference data set is particularly interesting for measurement methods that determine a vector of measurement data for each measurement point, for example in the form of a time series. To reduce the amount of data in an input vector assigned to an input grid point of a neural network, the most relevant data for determining a defect geometry can be selected from the vectors of measurement data in the reference data sets. Preferably, this selection is done by another neural network. This can be trained separately or together with the neural network for direct inversion. This approach reduces the amount of data to be processed in the neural network for inversion. The method can be carried out easier and faster.

Preferably, the neural network transforms input data with a two-dimensional spatial resolution into an output defect geometry with a three-dimensional spatial resolution. For this purpose, a neural network with one or more convolutional layers and/or one or more transposed convolutional layers is preferably used. For this purpose, an input layer of the neural network has a two-dimensional spatial resolution, where an input point of the input layer can be assigned a vector with multiple entries. The neural network is set up to generate an output with a three-dimensional spatial resolution based on this input data, which can be used as a three-dimensional output defect geometry or further transformed into a corresponding three-dimensional output defect geometry. The three-dimensional output defect geometry can be used particularly easily for the calculation of a prediction data set by the simulation routine.

In particular, the output of the neural network is assigned to the cells of the object grid. According to the output of the neural network, individual cells are marked as defective or defect-free. For example, from the obtained object grid with generic defect description, individual defects represented by groups of contiguous defect-bearing cells can then be transformed into a parametric defect description on a defect grid, simplifying any subsequent viewing and processing of the defect geometry.

Preferably, a classification of defects is carried out. Here defect-specific information is assigned to the detected defects. Defects can be differentiated, for example, into surface defects such as corrosion and defects in the volume such as cracks, inclusions or lamination defects. Laminating defects are regions in which individual materials forming the object are not sufficiently bonded together, at least locally. This makes it possible to describe the different types of defects, if necessary, in a subsequent iterative adjustment of the output defect geometry by different defect models. With the additional information, the adjustment of the output defect geometry in the subsequent iterative method can be more robust, simplified, and/or accelerated.

Different non-destructive measurement methods are the aforementioned MFL, EMAT, UT, and EC measurement methods. The method according to the invention is characterized in particular in that a data set based on an MFL, eddy current, EMAT or ultrasound measurement method is used as the first reference data set and a data set generated on the basis of a further measurement method from this group of measurement methods is used as at least one further reference data set. If a measurement method such as an EMAT method generates a data set with several sub-data sets, e.g. due to several sensors recording signals, all sub-data sets are then preferably used in the method. In the case of reference data obtained by means of EMAT methods, the reference data sets are preferably amplitudes (“counts”) integrated over time at the respective wall positions or measurement positions, the so-called A-scans.

Preferably, reference data sets of the following measurement methods in particular are used for the joint observation of in particular corrosion and cracks:
a) a first reference data set based on an MFL measurement and as a further reference data set based on an EMAT measurement, or
b) a first reference data set based on a MFL measurement and as a further reference data set based on a UT measurement, or
c) a first reference data set based on an MFL measurement, as a first further reference data set one based on an EMAT measurement, and as a second further reference data set one based on an EC measurement.

The reference data sets generated on the basis of MFL measurements can preferably be additionally differentiated with regard to the direction of magnetization, i.e. variants a), b) or c) can thus have either a reference data set based on an MFL measurement with magnetization in the axial direction (MFL-A measurement method) or based on a measurement with magnetization in the circumferential direction (MFL-C measurement method). Reference data sets obtained “on the basis” of a certain measurement method originate from corresponding measuring runs (“scans”) and, if necessary, are prepared for automated processing in the method according to the invention, e.g. they can be normalized with regard to their values and/or interpolated for the purpose of adjustment to certain grid geometries. In particular, they are available as two-dimensional data sets with respective length or width or circumference information and measurement values assigned to them.

Preferably, the iterative adjustment of the output defect geometry to the geometry of the real defects is performed by at least one, preferably a plurality of expert routines, in particular in competition with each other, each with at least one own search strategy or at least one own algorithm, which fall back on an identical output defect geometry. In particular, the expert routines are executed in parallel on one EDP unit. When using a single expert routine, it can access different algorithms to adjust the defect geometry.

In the respective expert routine(s), a respective expert defect geometry is generated by means of at least one own algorithm or search strategy and on the basis of the output defect geometry.

The expert routine has its own algorithm if at least one of the algorithms available to the expert routine for adjusting the defect geometry differs at least in part from the algorithms of another expert routine. Preferably, stochastic processes can be used to differentiate the algorithms of different expert routines. Each expert routine has at least one algorithm for adjusting the defect geometry, preferably at least one expert routine has several algorithms available. Likewise, within an expert routine, the selection of an algorithm can be based or can be predefined on stochastic processes.

Preferably, it is provided that a respective expert prediction data set is determined on the basis of the respective expert defect geometry, in particular by simulation or assignment of a measurement matching the respective reference data set, wherein the expert defect geometry underlying the respective expert prediction data set is made available to at least one, preferably several, and in particular all of the expert routines as a new output defect geometry for further adjustment to the geometry of the real defect(s), if the respective expert prediction data set is more similar to the respective reference data set than the corresponding output prediction data set and/or a fitness function considering the at least two expert prediction data sets is improved. Subsequently, i.e. for the next comparisons in the iteration of the respective expert defect geometries with the new output defect geometry, the expert prediction data sets belonging to the new output defect geometry are used as new output prediction data sets.

A measure of similarity can also be formed via the fitness function, so that, for example, in one embodiment a new output defect geometry is provided by an expert routine for the further iteration steps even if there is an approximation—albeit then a substantial one—of only one of the simulated or assigned expert prediction data sets to the respective reference data set.

For example, a simple comparison of the expert prediction data sets with the reference data sets based on the expert defect geometry results as follows:

$$E = {\sum }_{i} \vert {Y}_{cal}^{i} ( {x}_{1} … {x}_{n} ) - {Y}_{m}^{i} \vert ,$$

wherein Yₘⁱ—is the (geometrically usually two-dimensional present measurement data signal) of the i-th measurement method and Y_{cal}ⁱ is the simulated signal of the associated measurement method. Furthermore, x₁ . . . xₙ refers to the defect geometries varied via one or more expert routines. The smaller E is, the better the calculated defect geometries correspond to the actual ones.

Finally, iterative adjustment by means of the expert routines is performed until a stop criterion is satisfied. Preferably, (assigned or, in particular, simulated expert prediction data sets) generated on the basis of the same output defect geometry are compared with the respective reference data sets in a measurement method-specific manner, thus avoiding the disadvantages of the separate evaluation known from the prior art. In the measurement method-specific comparison, for example, a simulated EMAT scan is compared with the EMAT reference data set obtained based on the real measurement, a simulated MFL scan is compared with the MFL reference data set obtained based on the real measurement, and so on.

By accessing the same defect geometry and superimposing the geometries of different defects, the calculation of the burst pressures of the investigated object can be at least 10%-20% more accurate and, for example, a pipeline can be operated at higher pressures. Furthermore, due to the automated, combined observation of the reference data sets of different measurement methods and the resulting improved description of the defect geometries, an in-person inspection of the investigated object, e.g. by excavation, has to be performed less frequently. In addition, the combined evaluation of data obtained on the basis of different measurement methods minimizes the problem of singular, local solutions, i.e. the determination of the defect geometry behaves more robustly.

In the case of expert routines that are in particular in competition with each other, preference is preferably given to those with respect to the available resources of the EDP unit that are more successful in approximating the real measurement data than other expert routines existing in competition, as described below. Resources of the EDP unit are in particular the CPU or GPU time and/or the or a prioritization in the memory allocation.

Advantageously, the expert routines (on the EDP unit) run in competition with one another in such a way that the distribution of the resources of the EDP unit, in particular in the form of computing time, to a respective expert routine takes place as a function of a success rate, in which in particular the number of output defect geometries calculated by the expert routine and made available for one or more other expert routines is taken into account, and/or as a function of a reduction of a fitness function, in which in particular the number of expert prediction data sets generated for the reduction is taken into account. The competition between the expert routines results in particular from the fact that the program part designed as a monitoring routine allocates more resources to the respective expert routines, in particular in the form of computing time, preferably CPU or GPU time, if they are more successful than other expert routines. An expert routine is successful if it has found a defect geometry that matches the reference data set, for example a simulated EMAT measurement, and this geometry is made available to the other expert routines.

This can result, for example, in individual, particularly successful expert routines receiving more than 50% of the total available computing time, which significantly reduces the overall duration of the method according to the invention. At the same time, it can be specified on the program side that none or individual of the expert routines do not get below a certain percentage of computing time to avoid the problem of singular and exotic missing geometries or results from the individual routines. Thus, in the event that a previously successful expert routine finds only a local and not a global solution, a way out of the blockage situation that otherwise occurs in the prior art can be found.

Adjustment by means of the expert routines is performed until a stop criterion is satisfied. This is, for example, a residual difference with respect to the measured and simulated measurement data. It can also be an external stop criterion based, for example, on the available computing time or on a number of iterations that can be specified in particular or on a computing time that can be specified in particular or that is specified or determined from the available computing time. The stop criterion can also be a combination of these criteria.

According to a further development of the method according to the invention, the object grid is additionally generated automatically from the reference data sets. For determining the object grid, a classification of anomaly-free areas and anomaly-affected areas of the object is first carried out on the basis of at least parts of the reference data sets, wherein an output object grid is produced in particular on the basis of previously known information about the object, prediction data sets for the respective non-destructive measurement methods are calculated using the output object grid, at least parts of the prediction data sets are compared with respective parts of the reference data sets with exclusion of the anomaly-affected areas, and the output object grid is used as an object grid describing the geometry of the object as a function of at least one accuracy measure, or the output object grid is iteratively adjusted to the geometry of the object in the anomaly-free areas by means of the EDP unit.

Anomaly-affected areas of the reference data set are here spatial areas to which significantly deviating measurement data from neighboring areas are assigned. It is assumed that these anomalies are due to defects. In this context, anomaly-free areas are preferably contiguous areas in which the measured values measured by the non-destructive measurement method do not change or only change within a certain tolerance range, in which the gradient of the change remains below certain limit, the deviation of individual measured values from a mean value is less than a certain threshold value and/or the deviation of a mean value in a local area from adjacent local areas is below a threshold value.

For the determination of the object grid, according to the further development according to the invention, an output object grid can be created, wherein previously known information about the object is used, for example, in the case of pipelines, the pipeline diameter as well as the wall thickness. Starting from the output object grid, measurements matching the respective reference data set are simulated. Subsequently, a comparison of at least parts of the prediction data set with at least parts of the at least one reference data set is performed, wherein the anomaly-affected areas of the reference data set or the object are excluded in the comparison. If the compared data match sufficiently accurately, the output object grid is considered to be a sufficiently accurate representation of the true shape of the defect-free object and can be used as the basis for defect evaluation. Otherwise, an iterative adjustment of the output object grid to the geometry of the object in the anomaly-free areas takes place in the EDP unit.

For this purpose, a new output object grid is preferably created and new prediction data sets are calculated for it in turn. A comparison of at least parts of the new prediction data sets with at least parts of the at least one reference data set, excluding the anomalyaffected areas, is performed until an object stop criterion for the iterative adjustment, e.g. in the form of an accuracy measure, is reached. The output object grid then present is used as the object grid describing the geometry of the object.

In order to obtain an output object grid that represents the defect-free examined object in the evaluated section or in its entirety, an interpolation or extrapolation of information of the reference data set and/or object grid from the anomaly-free areas into the anomaly-affected areas preferably takes place. For example, after classifying the reference data sets into anomaly-affected and anomaly-free areas, the information from the anomaly-free areas can be interpolated and/or extrapolated into the anomaly-affected areas, and an auxiliary reference data set thus obtained can be used in determining the object grid. It is also conceivable to first create an object grid only for the areas classified as anomaly-free. This object grid has gaps in the region of the anomaly-affected areas, which can subsequently be closed by means of interpolation or extrapolation from the anomaly-free areas. In this way, an object grid representing the geometry of the object is obtained, which can then be used for further analysis of defects or defect geometries in the anomaly-affected areas.

Preferably, the classification of anomaly-free areas of the reference data sets involves an assignment of an anomaly-free area to at least one predefined local element of the object. This is used when creating the output object grid or inserted into the output object grid. This step simplifies the creation of an output object grid. As described above, the object examined by means of the non-destructive measurement methods may contain welds, fixtures and/or attachments, or have an otherwise previously known locally modified geometry. The creation of the object grid can be facilitated if this previously known information is used. For this purpose, corresponding elements such as weld seams, attachments such as support elements, clamps, reinforcing elements or, for example, sacrificial anodes of a cathodic rust protection system, as well as sleeves attached for repair purposes, are predefined in terms of their shape and/or extension. The measurement results of the non-destructive measurement methods naturally look different in these areas than in areas of an unchanged wall of the object, for example the pipeline wall in pipelines. However, these changes are uniform and large in area compared to most defects. Furthermore, the fact that the elements causing the change are known in their position makes them expectable.

By specifying the local elements, a recognition can be carried out in the classification whether this is for example a weld seam or a support structure. The element recognized in this way can then be used with its known general shape or general dimension in the creation of the output object grid, or subsequently introduced into the output object grid at the appropriate points in order to adapt it to the actual shape of the object under examination.

Particularly preferably, the respective local element, especially in the form of a weld seam, is described by means of a parametric geometry model. This can significantly reduce the effort required to create the object grid. For this purpose, the previously known information about the local element is used. For example, it may be known about a weld seam that it extends circumferentially around the object and can be described sufficiently accurately by a weld seam width and a superelevation. Thus, an adjustment of a predefined parametric geometry model of a local element to the actual local shape of the object can be done by varying only a few parameters. This significantly speeds up the method of creating an object grid. In particular, an iterative adjustment of the output object grid may involve a change in only one or more parameters of the parametric geometry model. The variation of individual parameters can also be limited by specific limits within which they can be modified. Such a limitation can minimize the risk of obtaining physically nonsensical results. The reliability of the method is increased.

In particular, several algorithms are available to an expert routine for adjusting the expert defect geometry. These can be approaches from the field of machine learning, stochastic optimization, empirical and/or numerical model functions. In particular, experience values of evaluating persons can be used in the expert routines. Preferably, defectspecific variations take place in one or more expert routines as described above, i.e. individual algorithms are designed to vary corrosion, cracks and lamination defects. This creates a sufficiently diverse approach to allow all solutions to be targeted and considered under competitive conditions.

In particular, several algorithms are available to an expert routine for adjusting the expert defect geometry. These can be approaches from the field of machine learning, stochastic optimization, empirical and/or numerical model functions. In particular, experience values of evaluating persons can be used in the expert routines. Preferably, defect-specific variations take place in one or more expert routines as described above, i.e. individual algorithms are designed to vary corrosion, cracks and lamination defects. This creates a sufficiently diverse approach to allow all solutions to be targeted and considered under competitive conditions.

Advantageously, different and defect-specific variations for generating the respective expert defect geometry are made in the expert routines, which in particular run in competition with each other, wherein in particular a first expert routine is provided for varying cracks, another for varying corrosion and/or another for varying lamination defects. Lamination defects, which have a disturbing effect in the form of non-connected layers of an (object) wall, e.g. in EC measurements, and which are detected in particular by special modes of the EMAT measurement, can thus be considered separately and, in particular, be disregarded for the consideration of the remaining service life of, e.g., a pipeline.

The object set out at the beginning is further solved by a method for determining a load limit of an object which is pressurized at least during operation and is designed in particular as an oil, gas or water pipeline, wherein in the method a data set describing one or more defects is used as an input data set in a calculation of the load limit which is designed in particular as forward modeling, wherein the input data set is first generated in accordance with the method described above or below for determining the geometry of a defect. The advantageous representation of the defect geometry, in particular as a nonparameterized true three-dimensional geometry or as a two-dimensional surface with respective depth values, makes simplifications previously assumed to be necessary in the industry superfluous, so that for this reason, too, an increase in the accuracy of the defect determination as a whole is ensured in a way that was previously unattainable.

Whereas previously accuracy was limited to specifying the point of maximum depth of the defect, now the entire profile is determined with high accuracy. Typically, the accuracy of the maximum depth is reduced to the level achievable as a function of the measurement accuracy, i.e. about ±5% of the wall thickness compared to about ±10% of the wall thickness in the case of sizing according to the prior art described at the beginning. However, the prediction of the load limit as a function of the geometry of the defect achieves increases in accuracy from, for example, ±50% previously to ±5% now, especially for critical cases. The advantage according to the invention thus lies in particular in an adequate representation of the defect geometry achieved for the first time, which makes precisely this increase possible in the first place.

Further advantages and details of the invention can be found in the following figure description. Schematically shows:

FIG. 1: a flowchart of an exemplary embodiment of a method for creating an output defect geometry,

FIG. 2: a method for creating training data of a neural network,

FIG. 3: a flowchart diagram of the functioning of the neural network.

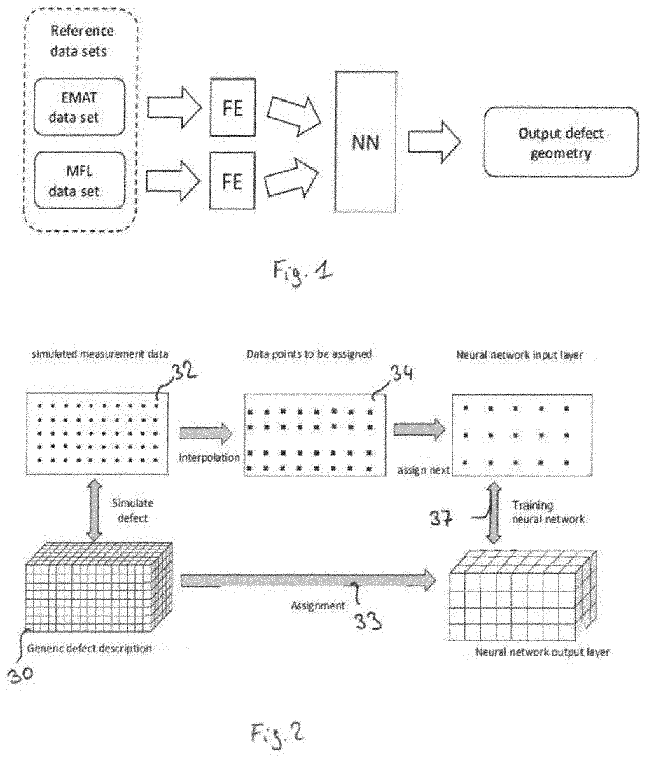

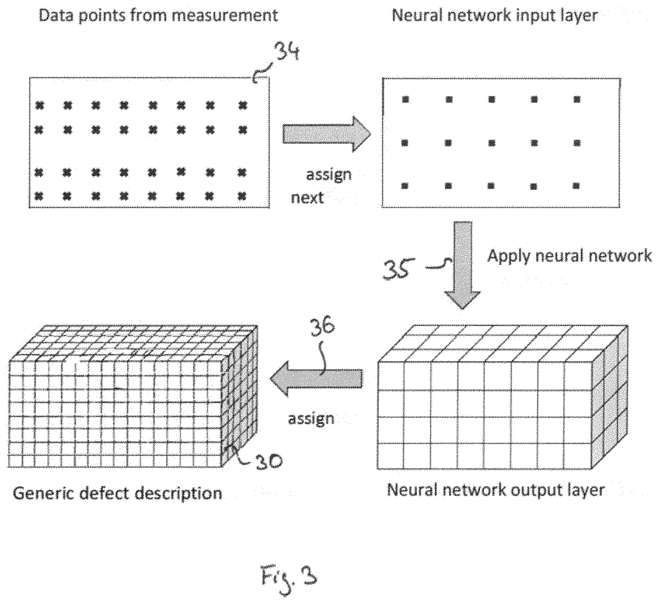

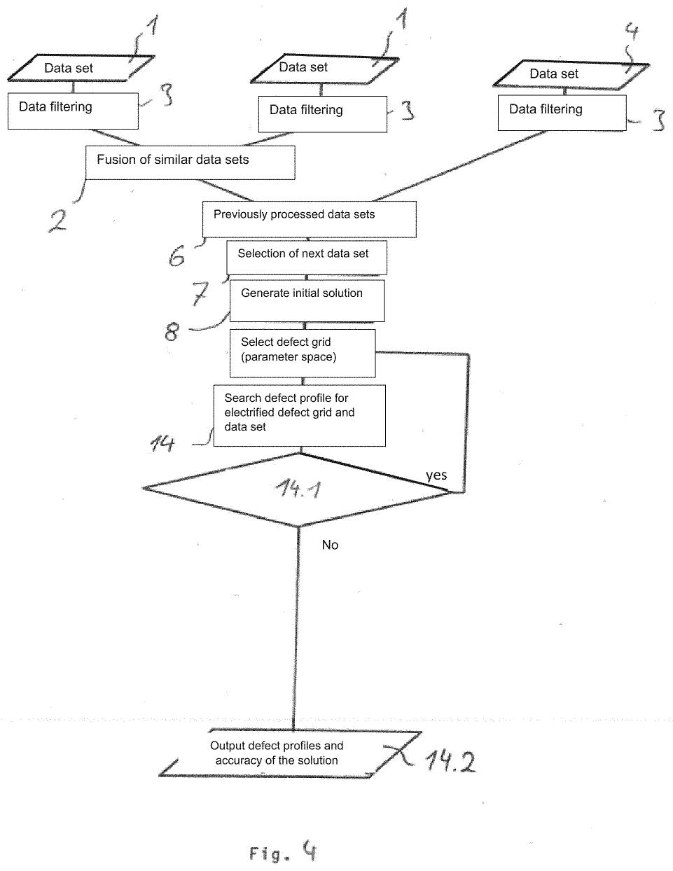

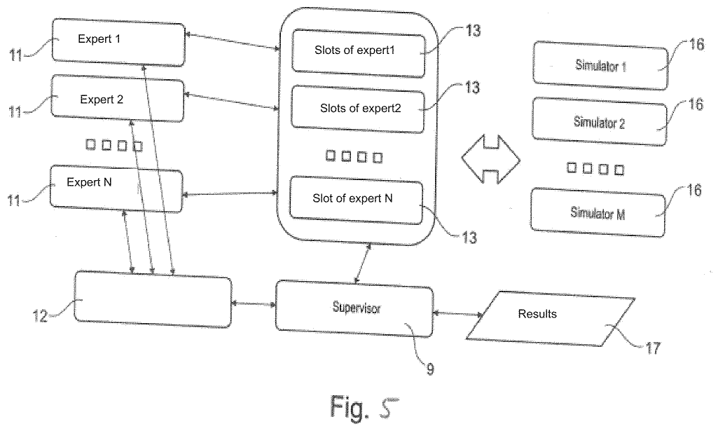

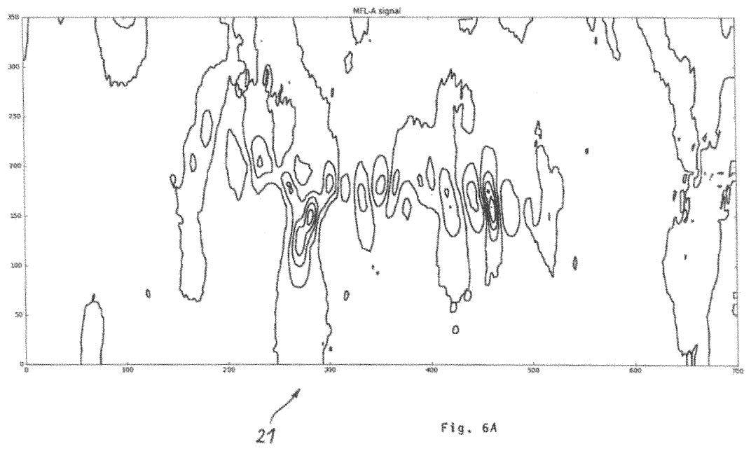

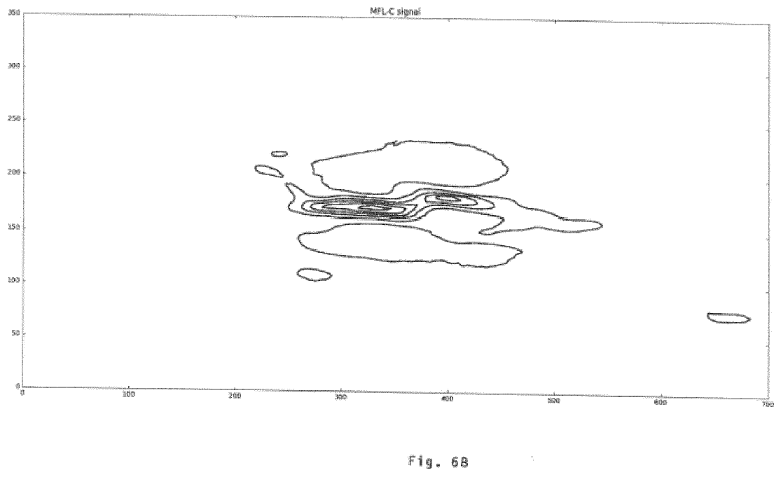

FIG. 4 a schematic representation of a further development of the method according to the invention,

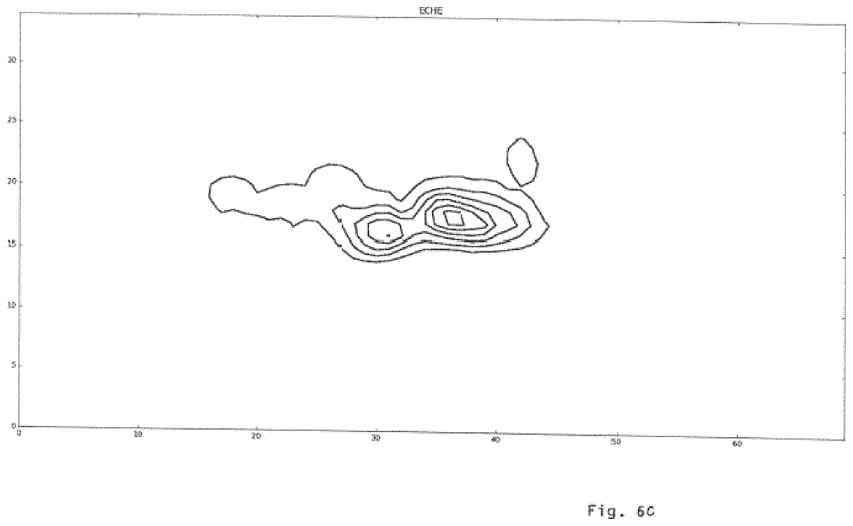

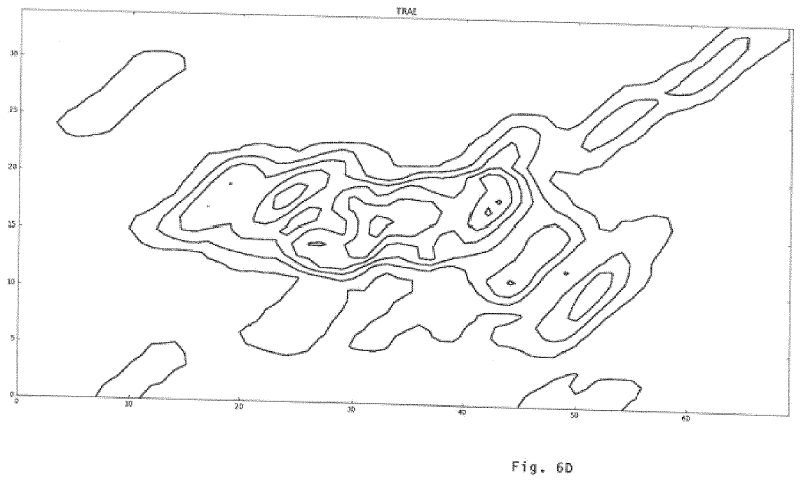

FIG. 5 a more detailed explanation of part of FIG. 4,

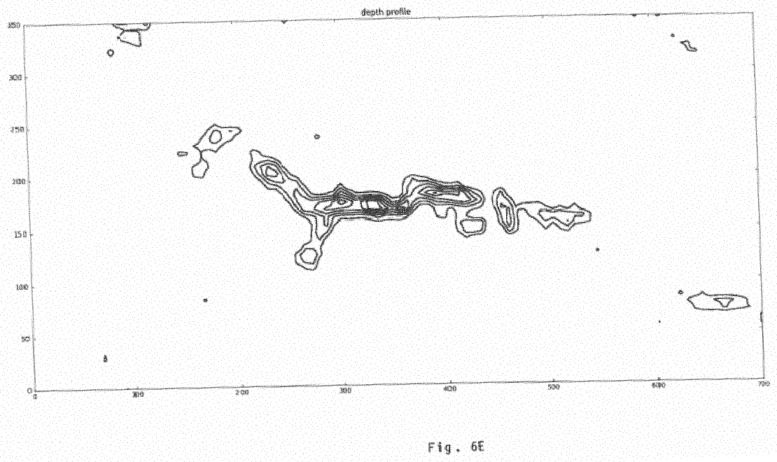

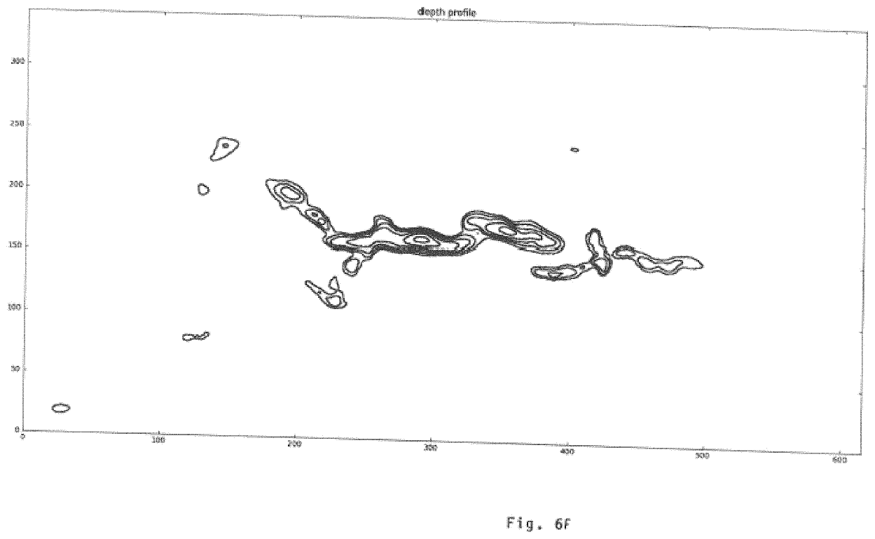

FIG. 6A-6F Reference data sets and result of a method according to the invention compared with a corresponding geometry scan,

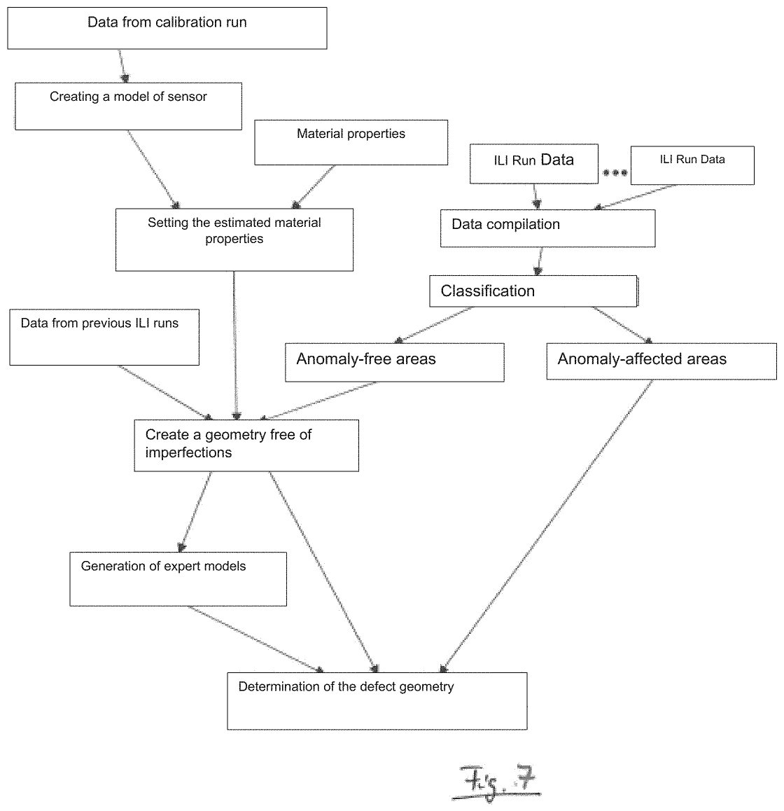

FIG. 7 a flow diagram of an exemplary embodiment of a method according to the invention,

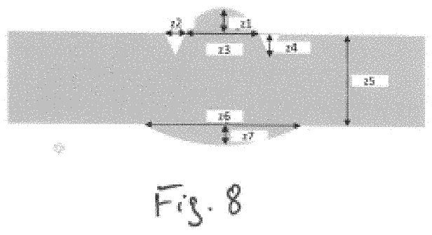

FIG. 8 an illustration of a parameter representation of a weld seam.

FIG. 1 shows part of an embodiment of a method for determining the geometry of one or more real examined defects. From a combined data set, presently comprising reference data sets obtained by two different non-destructive measurement methods (EMAT and MFL), data are extracted via respective feature extractors (FE) and transferred into a neural network (NN). The feature extractors (FE) can be formed here by further neural networks. Based on this data, the neural network (NN) is used to generate an output defect geometry that could underlie the reference data sets obtained by both or all of the non-destructive measurement methods performed. For this purpose, the neural network (NN) is assigned an input, which may consist of one or more vectors representing a twodimensional spatial resolution. The neural network (NN) outputs a vector representing a three-dimensional spatial resolution. This can be assigned to an object grid, where individual cells of the object grid are marked as having a defect, e.g. by assigning a value of “no material” or “material with defect”. In this marking, additional distinction can preferably be made according to the type of defect, such as cracks, corrosion or lamination defects.

FIG. 2 shows the creation of training data for a corresponding neural network (NN), and the use of this data for training. From a generic description of the defect 30 on an object grid, in step 31 the measurement data 32 obtained by means of a non-destructive measurement method on a corresponding defect geometry are simulated or assigned from a database. These are available with a two-dimensional spatial resolution. The neural network (NN) has an input layer (ES) whose input points represent a two-dimensional spatial resolution. The neural network (NN) is set up to generate output with three-dimensional spatial resolution, which is used as or transformed into a generic defect description 30. Individual data of the measurement data 32 are assigned to the individual grid points of the input layer of the neural network (step 34). At the same time, the location of the defects on the object grid is taken from the generic defect description. Here, those cells into or through which the defects extend are marked as having defects. This is done by assigning a corresponding value. Each cell of the object grid is assigned to the output layer of the neural network with the corresponding information whether it has a defect and, if so, the type of defect (step 33). These data pairs are used to train the neural network in step 37. Training of the neural network can then be done, for example, by comparing the output following from the data assigned to the input layer (ES) with the corresponding data assigned to the output layer of the neural network and adjusting weighting factors in the neural network by backpropagation. In this way, the neural network (NN) is trained with a large number of training data sets. If the feature extractors (FE) are also set up as neural networks, their training can be done simultaneously based on the same training data.

FIG. 3 shows the analysis of measurement data from a non-destructive measurement method using the neural network (NN). Measured values of the performed non-destructive measurement methods are assigned to the input points of the input layer (ES) of the neural network (NN) (step 34). The measured values are measured values from one or more reference data sets. The neural network (NN) generates an output representing three-dimensional location coordinates in step 35. This output is used for the creation of a general defect description, presently in the form of an output defect geometry. To this end, in step 36, the output of the neural network is assigned to the cells of the object grid 30. According to the output of the neural network, individual cells are marked as defective or defect-free. In addition, information on the type of defect in question, e.g. crack, corrosion, lamination defect, can be assigned if necessary. For example, from the obtained object grid with generic defect description, individual defects represented by groups of contiguous defect-bearing cells can then be transformed into a parametric defect description on a defect grid.

In the method according to the invention, according to one exemplary embodiment, the surface of a pipe is represented by a 2D mesh surface. The defect geometry can be described parameterized as a vector of depth values D lying on a defect grid. This defect geometry is compared with the output defect geometry on the basis of a result for a fitness function F(x₁ . . . xₙ) taking into account measurement and simulation data belonging to the respective geometry. Here, it is assumed that the lower the value of a fitness function, the closer the assumed expert defect geometry is to the real geometry:

$$F ( {x}_{1} … {x}_{n} ) = {\sum }_{i} ‖ {Y}_{cal}^{i} ( {x}_{1} … {x}_{n} ) - {Y}_{m}^{i} ‖ + R ( {x}_{1} … {x}_{n} )$$

Here, i is the number of data sets to be treated simultaneously (real and simulated data sets, respectively), Y_{cal}ⁱ is the result of a simulation of the corresponding i-th measurement, Yₘⁱ is the measured data of the respective reference data sets, and R(x₁ . . . xₙ) is a regularization term that can be used in case of ambiguities, e.g., due to multiple minima, and can be applied as follows:

R(x₁ . . . xₙ)=α∥(x₁ . . . xₙ)∥,

wherein α is a scaling term.

The method flow according to a further development is described at least in sections below according to FIG. 4, where a plurality of the expert routines 11 in parallel and in competition are described with only one block 14.

For example, multiple runs of the same MFL pipeline pig can be merged as input data sets according to box 2. Both data sets 1 can be filtered beforehand for better merging and aligned with each other (method step 3), for example to reduce any artifacts or background noise. Furthermore, another data set 4 based on another measurement method is processed as an additional reference data set in the associated box 3 and filtered for the purpose of matching to identical grid structures, so that according to method section 6 two matched reference data sets created on the basis of different non-destructive measurement methods are available.

Exactly matched data sets can be treated together, and the method according to the invention realizes the simultaneous treatment of the data sets by using a fitness function that takes into account the data sets to be considered together.

In step 7, the reference data sets available in step 6 are accessed, for which purpose an output defect geometry is first determined as the output defect geometry in step 8. As prescribed, this is done on the basis of a neural network into which the reference data sets are read as input data sets.

The neural network solution is then provided as one or more output defect geometries x₁ . . . xₙ for the individual expert modules. In advance, with the aim of reducing the computing time, the number of parameter values describing the defect geometries can be kept as small as possible. This is achieved, for example, via dynamic grid adjustment. Since the number of depth values corresponds to the number of nodes in the defect grid 5, the number of nodes can also be the number of defect parameters. Starting with a comparatively coarse grid, this is successively refined in relevant areas.

For example, for a given node distance of, for example, 14 mm, an associated grid cell size of 14 mm×14 mm, and defect limits of 30%, 50%, and 80% of wall thickness, refinement can be achieved in the relevant grid region, wherein those cells that exceed the above depth values are successively subdivided. The grid deformation then correlates with the assumed defect geometry, i.e. a larger number of grid points are located in areas of large gradients.

After a central grid of defects has been selected for all expert routines, a new defect-specific expert defect geometry is calculated in the respective expert routines in step 14 and in 14.1 it is checked whether this geometry must be made available to the other expert routines. This is the case if, as described above, e.g. a fitness function has been improved and no stop criterion has yet terminated the defect detection. In this case, the iteration continues with the defect geometry or geometries made available to the especially then all expert routines. Otherwise, in 14.2. the method is terminated with determination of the defect geometries and, in particular, indication of the accuracy of the solution. In addition, the burst pressure can be calculated on the basis of the defect geometries found.

On the EDP unit, according to the method of the invention, the workflow of a group of expert routines 11 competing with each other is simulated. For this purpose, the program can have various modules which, independently of each other and in particular not synchronized with each other, can set data in certain areas of the EDP unit so that they can be further processed there. This is done in particular under the supervision of a monitoring routine 9 (FIG. 5). A plurality of expert routines 11 thus holds a number of computational slots 13 depending on the success defined above, i.e. for example the number of output defect geometries written into a common memory area 12, in order to respectively generate expert defect geometries and/or perform associated MFL simulations or have them performed in the case of an independent MFL simulation module. This corresponds to block 14 shown in FIG. 4, where this is exemplary of several expert routines 11 (FIG. 5). Based on the individual computational slots 13, according to the present exemplary embodiment, the simulations of the measurement data matching the individual expert defect geometries for the purpose of creating the expert prediction data sets are also performed under the supervision of the monitoring routine 9 in the simulation modules 16. The more slots 13 are available for an expert routine, the greater is the share of EDP resources for that expert routine. Preferably, the number of program modules intended to run simulations is equal to the number of slots. The monitoring routine 9 monitors the number of iterations and the resulting changes in the output defect geometry, and further monitors whether an associated stop criterion has been reached. The result is then output according to block 17, which corresponds to block 14.2 from FIG. 4.

The number of computational slots 13 available for an expert routine 11 and the simulation routines subsequently made available can vary such that a first expert routine can utilize, as an example, up to 50% of the total computing time available for the computational slots and simulation routines.

In the memory area 12, the output defect geometries are stored as shown. This may be a memory area accessible to the expert routines 11. Log files of the expert routines 11 and monitoring routine 9 as well as instructions to the expert routines 11 can also be stored there, which are then implemented independently by them. For example, this can be an interrupt command that is set when the stop criterion is reached.

Preferably, the expert routines 11 are independent program modules that generate new expert defect geometries and set them in the simulation routines 16. Furthermore, the fitness function shown at the beginning can be generated in the expert routines 11 on the basis of the expert prediction data set and compared with the output prediction data set stored in the area 12. Provided that the expert prediction data sets are overall more similar to the reference data sets than the data sets stored in area 12, these expert prediction data sets are then used as new output prediction data sets.

For example, a new defect geometry is randomly generated in the expert routines 11. Machine learning algorithms or empirical rules can be used for this purpose. Advantageously, however, for further improved convergence of the solutions, the realization of at least two basic expert routines specific to the type of defect is provided as described below.

These search strategies, which are preferably always implemented in a method according to the invention, are based on an assumed probability distribution p(x,y) of grid points whose depth value results in a maximum reduction of the fitness function in order to determine a corrosion-based defect geometry. The probability function is used to identify N grid points (xₙ,yₙ). Instead of grid points xₙ,yₙ, the parameter representation of the group of defects (x₁ . . . xₙ) already used above can also be assumed as the object of the probability distribution, wherein for the purpose of simpler explanation, the probability distribution is referred to N grid points (x,y) or (xₙ,yₙ) in the following.

At each of the considered points, the depth function, which describes the depth D of the corrosion at the grid point, is changed by ΔD, wherein the sign of the change is randomly distributed. D is a set of parameters describing corrosion and is a subset of a common set of parameters describing defect geometry. Also the number of selected points N can be chosen randomly:

$${D}_{n e w} ( x , y ) = \{ \begin{matrix}D ( {x}_{n} , {y}_{n} ) ∓ Δ D , f ü r ausgewählte Punkte \\ D ( x , y ) , s o n s t\end{matrix}$$

With a choice of probability function p (x,y) different expert strategies can be realized, for example:

$$p ( x , y ) = \frac{D ( x , y )}{‖ D ( x , y ) ‖}$$

This algorithm realizes a variation of the defect depths, where the grid points with the largest depth are preferred. Another strategy for corrosion-based development of expert defect geometry may be as follows:

$$p ( x , y ) = \frac{{H}_{t h e b e s t} ( x , y ) - {H}_{m} ( x , y )}{‖ {H}_{t h e b e s t} ( x , y ) - {H}_{m} ( x , y ) ‖}$$

Such an algorithm varies the defect geometry at positions where the simulated MFL measurement signal H_{the best} for the best known solution has the largest difference from the measured signal Hₘ.

Based on this, different expert routines or their algorithms can be built by varying the number of grid points to be considered and the ΔD. As an example, the following six expert routines can be used for the development of corrosion-based defects:

$$1. p ( x , y ) = \frac{D ( x , y )}{‖ D ( x , y ) ‖} , N = 1 and Δ D = 1 \% Wall thickness$$

$$2. p ( x , y ) = \frac{D ( x , y )}{‖ D ( x , y ) ‖} , N = 2 and Δ D = 5 \% Wall thickness$$

$$3. p ( x , y ) = \frac{D ( x , y )}{‖ D ( x , y ) ‖} , N = 3 and Δ D = 5 \% Wall thickness \\ 4. p ( x , y ) = \frac{{H}_{t h e b e s t} ( x , y ) - {H}_{m} ( x , y )}{‖ {H}_{t h e b e s t} ( x , y ) - {H}_{m} ( x , y ) ‖} , \\ N = 1 and Δ D = 1 \% Wall thickness \\ 5. p ( x , y ) = \frac{{H}_{t h e b e s t} ( x , y ) - {H}_{m} ( x , y )}{‖ {H}_{t h e b e s t} ( x , y ) - {H}_{m} ( x , y ) ‖} , \\ N = 2 and Δ D = 5 \% Wall thickness$$

$$6. p ( x , y ) = \frac{{H}_{t h e b e s t} ( x , y ) - {H}_{m} ( x , y )}{‖ {H}_{t h e b e s t} ( x , y ) - {H}_{m} ( x , y ) ‖} , \\ N = 3 and Δ D = 5 \% Wall thickness$$

For an expert routine suitable for the variation of a crack-based defect, the following functional rules can be used:
the depth of the defect is randomly reduced or increased by a certain amount, preferably e.g. 1 or 2% of the wall thickness of the object,
the position of all points of the crack is varied in a randomly selected direction, and/or
a line describing the crack is lengthened or shortened by the position of the grid nodes on the object or defect grid.

An expert routine describing a lamination defect can operate according to the following functional rules:
based on the 2D parameter description of a lamination defect, the values associated with the grid nodes are varied stepwise by 5% in one direction or the other with the goal of varying the position of the lamination; this can also be done only for a subset of the knowns of the 2D description of the lamination,
randomly selected points (grid nodes) with non-zero values, which possess in the neighborhood of points with values of zero, can be set to zero (reducing the extent of lamination),
randomly selected grid points with values of zero that are in the neighborhood of grid points with non-zero values can be set to the corresponding neighborhood value, thereby increasing the lamination, and/or
all values in the grid can be moved in a randomly selected direction, which is accompanied by a change in the position of the lamination along the pipeline surface.

The monitoring routine 9 shown in FIG. 5 has two functions in particular, as described: firstly, the achievement of the stop criterion is checked and secondly, the allocation of the EDP unit resources between the individual experts is made based on their successes. One measure of success is

$$P = \frac{Δ F}{N} ,$$

wherein ΔF is the reduction of the fitness function F by the result of the respective expert routine and in this case now N is the number of simulations required for this. An evaluation of the n expert routines can be assumed to be

$${R}_{n} = \frac{{P}_{n}}{Σ {P}_{i}} .$$

. The number of computational slots Ns for an expert routine in one iteration is then

Ns=int(RₙNₐₗₗ)

wherein Nₐₗₗ is the number of all available slots.

In the simulation routines 16 the respective non-destructive measurements for the expert defect geometries are simulated. An expert routine can iterate until it finds a solution whose expert prediction records are better than the output prediction records stored in area 12. If this is the case, the expert routine 11 can try to achieve further better solutions starting from the already improved solution.

A resulting error E for the individual observations of the simulated and measured data sets can result from the errors of the respective data sets in the individual calculations:

E=Σᵢ∥Y_{cal}ⁱ(D)−Yₘⁱ[,

wherein Ym and Ycal represent the previously described, respective measured and simulated measurement fields at the defect geometries (x1 . . . xn).

To demonstrate the efficiency of the proposed method, a plurality of test scenarios were performed, wherein the data of two MFL inspection runs performed with magnetizations linearly independent of each other are used below according to FIGS. 6A and 6B. FIG. 6A shows data from a real MFL measurement with magnetization running in the axial direction at a signal strength between 22.2 and 30.6 kA/m, while those according to FIG. 6B result from a measurement made in the circumferential direction (signal strength 22.2 to 91.1 kA/m). The contour lines are evenly distributed over the indicated area in both figures. In addition, two data sets obtained by an EMAT method are used as reference data sets, wherein the data set shown in FIG. 6C shows the received signal of a receive transducer detecting reflections due to imperfections and the reference data set shown in FIG. 6D showing the associated transmission signal of a reference transducer. Normalized signals are shown in the form of counts. Both EMAT data sets are made available as input data for a neural network by means of a respective input layer after their processing, which comprises a series of Fourier transformations. Likewise, the two MFL data sets are made available to the neural network via respective input layers.

Using the neural network, an output defect geometry was determined on the EDP unit, which was then iteratively improved until a stop criterion was reached. The result of the method according to the invention is shown in FIG. 6E, which shows the depth of any defects on the inside of the pipeline section under consideration. Due to the method according to the invention, there is a high agreement with the real geometry determined by a laser scan (FIG. 6F). In both FIG. 6E and FIG. 6F, the contour lines indicate a range of 0 to 60% metal loss from the pipe wall. The combination of the MFL and EMAT measurement data in the method according to the present invention leads to a result more quickly than if, for example, only MFL data had been used. The time saving is around 20%. At the same time, the combined analysis of the two different measurement methods shows that the defects detected here are purely corrosion-based.

On the basis of the conventional consideration with the determination of the defect geometry established in the state of the art, the mentioned burst pressure of 4744.69 kPa results. Based on the method according to the invention, the defect geometry shown in FIG. 6F (contour lines at 2 mm depth) is obtained for the MFL data set and, based on this, a burst pressure of 8543.46 kPa. In this case, the burst pressure is as close as 99.4% to the burst pressure determined on the basis of the actual defect geometry determined by laser scanning. Accordingly, a pipeline examined according to the method of the invention can be operated with a safe operating pressure of 6520.53 kPa. This results in significant advantages for pipeline operators compared to the safe operating pressure of 3621.29 kPa based on the state of the art evaluation. The additional use of the EMAT reference data set neither worsened nor improved the result compared to the consideration of only the MFL data sets, since according to the method of the invention no cracks and no lamination or lamination defects were present in the considered pipe section, which would have negatively influenced the consideration of the burst pressures.

FIG. 7 again shows the sequence of a possible implementation of the method according to the invention. Based on measurement data 20 from one or more calibration measurements with a non-destructive measurement method on a calibration object of known geometry, in particular with defects of known geometry, a model the for the nondestructive sensor 21 is created. With an estimation of the relevant material properties of the examined object, a simulation routine is set up in step 22. This can be done by specifying known parameters representing the material properties as well as properties of the sensor used. Alternatively or additionally, an iterative adjustment of the parameters can be performed until the results of the simulation routine for the used non-destructive measurement method based on the known geometry of the calibration object match the measurement data of the calibration measurement sufficiently accurately. The simulation routine can also be prepared and reused for multiple measurements using the non-destructive measurement method.

Based on one or more measurements with one or more non-destructive measurement methods, one or more reference data sets are created. FIG. 7 shows in step 2 the creation of a reference data set based on several measurement runs. Based on the reference data set, a classification is performed in step 23 into anomaly-free areas and anomaly-affected areas. Different criteria can be used to distinguish anomaly-free areas from anomaly-affected areas. By using two or more reference data sets obtained on the basis of different non-destructive measurement methods, the classification can be further improved in such a way that individual measurement methods are more sensitive to certain defects than to others.

Based on the anomaly-free areas and using the simulation routine, an object grid representing the intact geometry of the object is created in step 24. For this purpose, information from previous measurement runs can also be used in the object that is then still without defects or with fewer defects. For this purpose, the object grid can be created in the anomaly-free areas and then completed by extrapolating and/or interpolating into the anomaly-affected areas. It is also conceivable to perform interpolation and/or extrapolation based on the reference data sets from the anomaly-free areas to the anomalyaffected areas.

The creation of the object grid is done through an iterative process. A first output object grid is guessed or given, for example, based on an estimated object geometry. This is adjusted in an iterative method. For example, an output object grid may have a weld seam according to the one shown in cross-section in FIG. 8. The output grid can be iteratively adjusted until it has a shape representing the weld seam.

In particular, to speed up the method, a parametric description of the weld seam by a parametric geometry model can also be used. FIG. 8 shows such a parametric geometry model. In this model, the shape of the weld seam is described by a small number of parameters, presently seven. The parameters describe the wall thickness of the object (z5), the respective extent of the weld seam on both sides (z3, z6), the weld seam protrusion (z1, z7), and the width and depth of notches on the weld seam (z2, z4). The object grid can thus be modified in the area of the weld seam by adjusting a small number of parameters. In this case, previously known information about a general shape of an object area, in this case a weld seam, is used. In addition, boundary conditions can be specified for individual parameters. This excludes physically nonsensical or impossible results. For example, in FIG. 8, the parameters z2, z3, z5, and z6 cannot be meaningfully negative, z4 cannot be meaningfully greater than z5, etc. The parameter values can be determined by the following optimization problem:

$$\{ {z}_{1} … {z}_{n} \} = arg min {\sum }_{i} \vert {Y}_{cal}^{i} ( {z}_{1} … {z}_{n} ) - {Y}_{m}^{i} \vert \\ under boundary conditions for \{ {z}_{1} … {z}_{n} \}$$

with Yₘⁱ—measured signal of the i-th measurement, Y_{cal}ⁱ calculated signal for the i

measurement. Values for the parameters can be determined via derivative-free optimization algorithms, for example using random search. To speed up the method, a changeability of the parameters in fixed steps, preferably defined as a function of the wall thickness, can be specified. For example, a change can be made in increments that are 1% of the wall thickness.

Due to the method according to the invention, the condition of a pipe and thus the pressure that can be applied for safe operation of the pipeline can be indicated much more realistically, while operational safety is still guaranteed. The method according to the invention with the expert routines competing for resources of the EDP unit can make such a result available to pipeline operators faster or at least in the same evaluation time as in the prior art.

1. Method for determining the geometry of one or more real, examined defects of a metallic, in particular magnetizable object, in particular a pipe or a tank, by means of at least two reference data sets of the object generated on the basis of different, non-destructive measurement methods,
wherein the object is at least partially represented on or by an at least two-dimensional, preferably three-dimensional, object grid, in an EDP unit,
wherein an output defect geometry, in particular on the object grid or an at least twodimensional defect grid, is generated by inversion of at least parts of the reference data sets, in particular by at least one neural network (NN) trained for this object, a respective prediction data set for the non-destructive measurement methods used in the generation of the reference data sets is calculated on the basis of the output defect geometry by a simulation routine, a comparison of at least parts of the prediction data sets with at least parts of the reference data sets is carried out and, depending on at least one accuracy measure, the method for determining the geometry of the defect is terminated or an iterative adjustment of the output defect geometry to the geometry of the real defect(s) is carried out.

2. The method according to claim 1, characterized in that a training simulation routine generates training data by simulation based on different training geometries, with which a neural network (NN) is trained to invert the measurement data.

3. The method according to any one of claim 1 or 2, characterized in that the neural network (NN) is trained based on data from a database containing simulated measurements.

4. The method according to any one of claims 1 to 3, characterized in that input data for the neural network (NN) are extracted from a reference data set by a feature extractor (FE), which is preferably designed as a further neural network.

5. The method according to any one of claims 1 to 4, characterized in that by means of the neural network (NN) input data with a two-dimensional spatial resolution are converted into an output defect geometry with a three-dimensional spatial resolution.

6. The method according to any one of claims 1 to 5, characterized in that a classification of defects is performed by the neural network (NN).

7. The method according to any one of claims 1 to 6, characterized in that a data set based on an MFL, eddy current, EMAT or ultrasound measurement method is used as a first reference data set and at least one further reference data set is a data set generated on the basis of a further measurement method generating from this group of measurement methods.

8. The method according to any one of claims 1 to 7, characterized in that the iterative adjustment of the output defect geometry to the geometry of the real defect(s) is carried out by means of the EDP unit and by means of at least one, preferably several, expert routines (11) running in particular in competition and further in particular in parallel with each other,
wherein in the respective expert routine(s) (11) a respective expert defect geometry is generated by means of at least one own algorithm and on the basis of the output defect geometry,
on the basis of the respective expert defect geometry, respective expert prediction data sets are determined by simulation or assignment of a measurement corresponding to the respective reference data set,
and the expert defect geometry on which the respective expert prediction data sets are based is then made available to at least one, in particular all, of the expert routines (11) as a new output defect geometry for further adjustment to the geometry of the real defect(s), if the expert prediction data sets of a respective expert routine are more similar to the respective reference data sets than the output prediction data sets and/or a fitness function considering the at least two expert prediction data sets is improved,
and then the expert prediction data sets associated with the new output defect geometry are used as the new output prediction data sets,
wherein the iterative adjustment is performed by means of the expert routines (11) until a stop criterion is satisfied.

9. The method according to claim 8, characterized in that the expert routines (11) run in competition with one another in such a way that a distribution of the resources of the EDP unit to a respective expert routine, in particular in the form of computing time, preferably CPU time and/or GPU time, as a function of a success rate, in which in particular the number of output defect location geometries calculated by this expert routine and made available for one or more other expert routines (11) is taken into account, and/or as a function of a reduction of the fitness function, in which in particular the number of expert prediction data sets generated for the reduction is taken into account.

10. The method according to any one of the preceding claims, characterized in that, in order to determine the object grid, a classification of anomaly-free areas and anomalyaffected areas of the object is first carried out on the basis of at least parts of the reference data sets, wherein an output object grid is produced in particular on the basis of previously known information about the object, prediction data sets for the respective non-destructive measurement methods are calculated using the output object grid, at least parts of the prediction data sets are compared with respective parts of the reference data sets with exclusion of the anomaly-affected areas, and the output object grid is used as an object grid describing the geometry of the object as a function of at least one accuracy measure, or the output object grid is iteratively adjusted to the geometry of the object in the anomalyfree areas by means of the EDP unit.

11. The method according to claim 10, characterized in that, in the iterative adjustment of the output object grid, a new output object grid is created and new prediction data sets are calculated for it, and a comparison of at least parts of the new prediction data sets with corresponding parts of the reference data sets is carried out with exclusion of the anomaly-affected areas until an object stop criterion is satisfied, wherein the output object grid then present is used as an object grid describing the geometry of the object.

12. The method according to any one of the preceding claim 10 or 11, characterized in that during the classification an assignment of an anomaly-free area to at least one predefined local element of the object is performed and this is used in the creation of the output object grid or is inserted into the output object grid.

13. The method according to claim 12, characterized in that the local element, which is formed in particular in the form of a weld seam, is described by means of a parametric geometry model.

14. The method according to any one of claims 8 to 13, characterized in that a comparison of the variation of the expert prediction data set with the measurement variation of the real data set is used as stop criterion.

15. The method according to any one of claims 8 to 14, characterized in that different and defect-specific variations are made in the expert routine or routines (11) for generating the expert defect geometry, wherein in particular a first expert routine (11) is provided for varying cracks, another for varying corrosion and/or another for varying lamination defects.

16. A method for determining a load limit of an object which is pressurized at least during operation and is designed in particular as an oil, gas or water pipeline, in which a data set describing one or more defect(s) is used as an input data set in a calculation of the load limit, characterized in that the input data set is first determined in accordance with a method according to any one of the preceding claims.
